(19) United States
(12) Patent Application Publication
(10) Pub. No.: US 2013/0217797 A1
(43) Pub. Date: Aug. 22, 2013

(54) MICROEMULSIONS

(71) Applicants: Marc FRICKE, Osnabrueck (DE); Markus SCHUETTE, Osnabrueck (DE); Thorsten Martin STAUDT, Mannheim (DE); Christian HOLTZE, Mannheim (DE); Sebastian KOCH, Lemfoerde (DE); Frank BARTELS, Mannheim (DE)

(72) Inventors: Marc FRICKE, Osnabrueck (DE); Markus SCHUETTE, Osnabrueck (DE); Thorsten Martin STAUDT, Mannheim (DE); Christian HOLTZE, Mannheim (DE); Sebastian KOCH, Lemfoerde (DE); Frank BARTELS, Mannheim (DE)

(73) Assignee: BASF SE, Ludwigshafen (DE)

(21) Appl. No.: 13/590,345

(22) Filed: Aug. 21, 2012

Related U.S. Application Data
(60) Provisional application No. 61/526,291, filed on Aug. 23, 2011.

(51) Int. Cl. C08G 18/48

(52) U.S. Cl. CPC C08G 18/4829
USPC 521/170; 516/20

(57) ABSTRACT

The invention provides microemulsions comprising
a) at least one compound having two or more isocyanate-reactive hydrogen atoms,
b) at least one apolar organic compound,
c) at least one halogen-free compound effective in causing said compounds a) and b) to build a microemulsion, comprising at least one amphiphilic compound ci) selected from the group consisting of nonionic surfactants, polymers and mixtures thereof, and at least one compound cii), other than ci), selected from compounds having an apolar portion having a carbon chain length of 6 or more and one or more OH or NH groups as polar portion and mixtures thereof.

### Description

The present invention relates to microemulsions useful for the production of polyurethane foams in particular.

Polyurethane foams and their method of making are long known. Typically, they are obtained by reacting polyisocyanates with compounds having two or more isocyanate-reactive hydrogen atoms in the presence of blowing agents.

It is customary to add the blowing agents to one of the reactant components before the reaction. Usually, the blowing agents are added to the compounds having two isocyanate-reactive hydrogen atoms.

Physical blowing agents are often used. They are typically compounds that are inert to the starting compounds of polyurethane synthesis and that are liquid at room temperature and vaporize at the temperatures involved in urethane formation.

The physical blowing agents used are often apolar compounds, especially hydrocarbons. These are usually admixed to the compounds having two or more isocyanate-reactive hydrogen atoms. Owing to the apolar character of hydrocarbons, problems often arise with the solubility of these compounds with the compounds having two or more isocyanate-reactive hydrogen atoms, usually polyols.

These problems can be solved using solubilizers for example. However, solubilizers can have an adverse effect on foam processing and properties.

The solubility of blowing agents in the compounds having two or more isocyanate-reactive hydrogen atoms can also be improved by selecting specific representatives of these compounds. For instance, polyether alcohols started with amines will improve the solubility. However, polyols of this type are not suitable for all fields of use and, what is more, the additionally dissolved amount of blowing agent is only limited.

One way to incorporate apolar compounds in the polyol component is to form emulsions.

Emulsions are disperse systems of two or more mutually immiscible liquids. One of the liquid phases forms a dispersion medium (also known as the external, continuous or coherent phase), in which the other phase (also known as the internal or disperse phase) is dispersed in the form of fine droplets. Depending on the size of dispersed particles and on the kinetic or thermodynamic stability, there are macro-or else coarsely disperse emulsions and micro-or else colloidally disperse emulsions. Particle diameter or structure size varies between 10⁻⁴ and 10⁻⁸ cm, i.e., in the nano-to micrometer range, most emulsions have a nonunitary particle size and are polydisperse. Depending on the size of dispersed particles and the refractive index difference between continuous phase and disperse phase, emulsions are milkily cloudy (macroemulsion) to clear (microemulsion).

Microemulsions are particularly useful.

Emulsions for the stated purpose are known from the prior art.

DE 69213166 describes the use of fluorinated inert organic liquids such as perfluorobutyltetrahydrofuran in combination with fluorine-containing surface-active agents such as FC 430 from 3M for production of emulsions/microemulsions, wherein an isocyanate prepolymer is used. The prepolymer is obtained by reaction of PMDI with low molecular weight glycols. However, halogenated compounds of this type are costly and ecologically concerning.

DE 4121161 describes the production of rigid polyurethane foams using vinylperfluoroalkanes, such as mixtures of vinylperfluoro-n-butane and 1-H-perfluorohexane, wherein the fluorinated compounds form an emulsion in one of the two components as in the polyol blend for example. This provides foams having finer cells and lower thermal conductivity. Milky emulsions are obtained, but not microemulsions. Concerning the disadvantages, the above remarks apply.

DE 19742011 describes the use of specific polyols for producing halogen-free emulsions useful as polyol blends for production of rigid foams. The polyols are propylene oxide-ethylene oxide block copolymers having an ethylene oxide tip and an OH number between 10 and 100 mgKOH/g. Microemulsions are not concerned here.

DE 19742010 discloses the use of specific polyols for producing halogen-free emulsions useful as polyol blends for production of rigid foams. The polyols are polyester alcohols. Microemulsions are not obtained.

DE 69212342 describes the use of fluorinated alkanes for forming microemulsions for polyol blends for production of specific very fine-cell and open-cell rigid foams used as core material for production of vacuum insulation panels. The fine-cell character is achieved via fluorine additives and the open-cell character via cyclic carbonates such as glycerol carbonate, Fixapret CNF. The F-additives used include, for example, perfluoropentane or perfluoro-2-butyltetrahydrofuran. Concerning the disadvantages of fluorinated compounds, the above remarks apply.

EP 0824123 describes the use of tert-butanol as an emulsifier for producing phase-stable polyol blends for the production of rigid foams, for example for refrigerator applications, comprising cyclopentane as a blowing agent. Again, microemulsions are not concerned.

U.S. Pat. No. 4,826,623 describes the production of polyol blends for rigid polyurethane foams comprising microemulsions in order to eliminate incompatibilities between halogenated polyols, used as flame retardants, and halogenated blowing agent. The emulsifiers used are, for example, mixtures of dimethyl methyiphosphonate (MeP(O)(OMe)2) and ethoxylated monoalcohols or else classic polyether diols with propylene oxide backbone and ethylene oxide end-block in the chain. Emulsions of apolar blowing agents are not concerned here.

“Making polyurethane foams from microemulsions”, C. Ligoure et al., Polymer 46 (2005) 6402-6410 describes rigid polyisocyanurate (PIR) foams based on microemulsions of n-pentane in polyols. No stable emulsion is obtained without surfactant or with a fluorinated surfactant; a silicone surfactant (L6900, PDMS polyether graft copolymer from Union Carbide) allegedly gives microemulsions, but only in a small intermediate phase. Even with 8.5 parts by weight of surfactant the formulation phase-separates into blowing, polyol and intermediate phases. Such systems have no industrial utility.

“Polyurethanes via Microemulsion Polymerization”, J. Texter and P. Ziemer, Macromolecules 37 (2004), 5841-5843 describes the polymerization of polyurethanes by proceeding from microemulsions of immiscible monomers. The surfactant used is bis(2-ethylhexyl) sulfosuccinate sodium salt (AOT). Water-based foams are mentioned at the end. The products mentioned therein are not polyurethane foams.

It is an object of the present invention to provide polyurethane foam production components that form stable systems with apolar compounds, for example apolar blowing agents. Polyurethane foams produced using these components shall have a uniform cellular structure, a small size of cell and good mechanical properties.

We have found that this object is achieved, surprisingly, when the apolar compounds and the compounds having two or more isocyanate-reactive hydrogen atoms are in the form of a microemulsion.

Microemulsions are water-oil-surfactant mixtures i.e., mixtures of polar compounds, apolar compounds and surfactants, which, unlike other emulsions, are thermodynamically stable. They are optically transparent and form without the high energy input otherwise needed to produce emulsions. Cosurfactants are usually used for preparing a microemulsion. Cosolvents can optionally also be used. Microemulsions only form in certain domains of the phase diagrams of ternary or else quaternary systems.

Microemulsions are thus mixtures of two mutually immiscible liquids and at least one nonionic or ionic surfactant comprising one or more hydrophobic moieties.

The invention accordingly provides microemulsions comprising
a) at least one compound having two or more isocyanate-reactive hydrogen atoms,
b) at least one apolar organic compound,
c) at least one halogen-free compound effective in causing said compounds a) and b) to build a microemulsion, comprising at least one amphiphilic compound ci) selected from the group consisting of nonionic surfactants, polymers and mixtures thereof, and at least one compound cii), other than ci), selected from compounds having an apolar portion having a carbon chain length of 6 or more and one or more OH or NH groups as polar portion and mixtures thereof.

Preferably, the apolar organic compound b) is selected from the group comprising alkanes having an unbranched chain and 3 to 7 carbon atoms in the molecule, alkanes having a branched chain and 3 to 7 carbon atoms in the molecule, cycloalkanes having 3 to 7 carbon atoms in the molecule and alkenes having 3 to 7 carbons in the molecule.

In one preferable embodiment of the invention, the apolar organic compound b) is selected from the group comprising alkanes having an unbranched chain and 3 to 7 carbon atoms in the molecule, alkanes having a branched chain and 3 to 7 carbon atoms in the molecule, cycloalkanes having 3 to 7 carbon atoms in the molecule.

Preferable compounds b) are n-pentane, isopentane, cyclopentane and any desired mixtures of two or more thereof. Cyclopentane is particularly preferable.

In principle, the apolar organic compound b) may also comprise compounds comprising fluorine. These are preferably fluorinated and/or perfluorinated linear, branched and/or cycloaliphatic compounds having 3 to 7 carbon atoms in the molecule. When compounds of this type are used, their amount should not exceed 10% by weight, based on the weight of component b).

Component b) is preferably used in an amount of 5% to 20% by weight, based on the weight of the microemulsion.

Component a) is preferably selected from the group comprising polyether alcohols and polyester alcohols. It is particularly preferable for component a) to be at least one polyether alcohol.

In one particularly preferable embodiment of the invention, component a) is at least one polyether alcohol having a functionality of 2 to 8 and a molecular weight Mw of 400 to 10 000.

According to the invention, compound c) comprises at least one amphiphilic compound ci) and at least one compound cii) other than ci). The term amphiphilic designates the chemical property of a substance being both hydrophilic and lipophilic. As a result, it can readily interact both with polar solvents and with apolar solvents. This is because the molecules have both polar and apolar regions.

According to the invention, nonionic surfactants and polymers are used as component ci).

The amphiphilic molecules preferably used as component ci) consist particularly of one or more apolar groups comprising carbon chains of more than 8 carbon atoms. Examples thereof are lauryl, oleyl and stearyl. Commercial surfactants may be concerned here. These compounds typically have fewer than 30 carbon atoms. Examples are polyisobutylene, poly(ethylene-co-butylene), optionally also silicone groups, with the proviso that the hydrophobic groups do not crystallize in the formulation, and that the polar groups are compatible with the polyol component. Examples thereof are alkoxylates with polyethylene glycol or polypropylene glycol and/or with sugars or mixtures thereof. Fatty amine alkoxides or fatty acid amine alkoxides may also be used.

What connects the polar and apolar groups in the molecule may be an ether bond or an ester bond.

Preferably, these compounds should have a low HLB value, particularly below 10, i.e., little alkoxylate compared with the number of carbon atoms. A preferred example is 2 ethylene oxide units per 18 carbon atoms or more preferably fatty alcohols with 0 ethylene oxide units. The number of carbon atoms in the polar group is preferably less than the number of carbon atoms in the apolar group.

Corresponding compounds having a low critical micelle concentration (CMC) are also advantageous according to the present invention. Corresponding compounds having a low critical aggregation concentration (CAC) are also further advantageous.

Component cii) in the present invention is a compound which is other than ci) and is selected from compounds having an apolar portion having a carbon chain length of 6 or more and one or more OH or NH groups as polar portion and mixtures thereof. According to the present invention, the apolar portion of a compound useful as compound cii) has not more than 18 carbon atoms and preferably not more than 16 carbon atoms. One example thereof is n-alcohols. However, component cii) may also be a methyl-capped alkoxylate, or comprise polar groups as mentioned for ci).

The weight ratio of component ci to cii is for example from 0.1 to 10, preferably from 0.5 to 5 and more preferably from 0.8 to 2.

In one embodiment of the invention, component cii) is a hydrophobic compound.

Preference is given to using nonionic compounds as component cii).

In addition to components ci) and cii), according to the invention at least one further surfactant can also additionally be used in the microemulsion according to the invention. According to the invention, surfactants known to a person skilled in the art, for example selected from the abovementioned groups, can generally be used for this purpose.

The amount in which component c) is used is preferably from above 0% to below 20% by weight, more preferably from above 0% to 16% by weight and even more preferably from above 0% to 10% by weight, all based on the weight of the sum of components a), b) and c). The exact quantity used depends on the formulation.

Preferably, the microemulsions are optically clear. This is to be understood as meaning that they have a transmission of 90% at a path length of 1 cm and light wavelength of 700 nm.

The microemulsions preferably have a characteristic, monotonously descending, sigmoidal signal and structures, i.e., swollen micelles, having a radius between 2 and 40 nm, more preferably between 5 and 40 nm, even more preferably between 10 and 40 nm and more particularly between 20 and 30 nm assuming a globular model in small angle x-ray scattering (SAXS).

The microemulsions of the present invention can further also have different internal structures. In contradistinction to microemulsions where there are swollen micelles, i.e., globular structures, the microemulsions in one embodiment of the present invention are bicontinuous in that the two phases interpenetrate each other to a much greater extent. Bicontinuous microemulsions of the present invention display a characteristic peak in the nm range, typically from 40 to 100 nm for example, in SAXS measurements and can thereby be distinguished from micellar microemulsions.

The present invention accordingly also provides a microemulsion which is in accordance with the present invention while in bicontinuous form; that is, these bicontinuous microemulsions of the present invention have a characteristic SAXS peak in the nm range, typically from 40 to 100 nm for example.

The SAXS measurements were carried out using a SAXSess (Anton Paar GmbH, Graz, Austria) in slit collimation. The Cu K_{α} line was used as source for the x-rays (40 kV, 40 mA), monochromatized with Göbel mirrors. An imaging plate detector was used to accumulate the scattered x-rays. Measurement temperature was 20° C., measurement time was 2 minutes, and the distance between the sample and the detector was 261.2 mm. The sample was prepared in a capillary. The measured data were cleaned up using SAXSess software.

SAXSess measures the radiation scattered by a sample. The sample is irradiated with precisely defined x-rays. The angle at which the radiation is detected can be set between 0.05° and 5°. This range comprises information about structures in the nanometer range.

The microemulsions according to the invention are obtainable in different ways.

In one embodiment of the invention, all the constituents of the microemulsion are combined and mixed to produce the microemulsion.

In a further preferable embodiment of the invention, first component a) is mixed with component b) and this mixture is admixed with component c) to form the microemulsion.

In a further, preferable embodiment of the invention, first component a) is mixed with component c). This mixture is stable and can be stored for a long time. This mixture is later mixed with component b) to form the microemulsion.

Mixing preferably takes the form of mechanical stirring in all cases. It may be advantageous to heat the mixture.

In a further preferable embodiment of the invention, first a portion of component a) is mixed with components b) and c). This leads to the formation of a comparatively highly concentrated microemulsion. This concentrate can be adapted to the particular end use by adding the component a) quantity required for further processing. This version can improve the logistics of providing polyurethane systems. It is made possible by the outstanding stability of the microemulsions of the present invention in storage and the possibility of incorporating in the microemulsions even comparatively large amounts of component b) without problems arising in relation to storage stability. The remainder of component a) can be added as early as during storage of the microemulsion. In one preferable embodiment of the invention, the remainder of component a) can also be added immediately before the production of foams, for example in the mixing head in which the polyol component and the isocyanate component are mixed.

Useful compounds having two or more isocyanate-reactive hydrogen atoms (component a) include those having at least two reactive groups selected from OH groups, SH groups, NH groups, NH2 groups and carbon-acid groups. Preferably, the reactive groups are OH groups.

It is particularly preferable for the compounds of component a) to be polyether alcohols and/or polyester alcohols.

Component a) polyester alcohols are usually prepared by condensation of polyfunctional alcohols, preferably diols, having 2 to 12 carbon atoms, preferably 2 to 6 carbon atoms, with polyfunctional carboxylic acids having 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthal acid, terephthalic acid and the isomeric naphthalenedicarboxylic acids. In one preferable embodiment of the invention, the carboxylic acids are aromatic carboxylic acids in that phthalic acid, terephthalic acid and mixtures thereof are used. The phthalic acid used in the synthesis of polyester alcohols is preferably in the form of its anhydride.

Polyester alcohols preferably have a hydroxyl number in the range between 50 and 300 mgKOH/g and a functionality in the range between 2 and 4.

Preference is given to using polyether alcohols as component a).

Component a) polyether alcohols usually have a functionality between 2 and 8 and especially in the range from 3 to 8.

Polyether alcohols used in particular are prepared by known methods, for example by anionic polymerization of alkylene oxides in the presence of catalysts, preferably alkali metal hydroxides.

Alkylene oxides used are usually ethylene oxide and/or propylene oxide.

Useful starter molecules include particularly compounds having at least 2 hydroxyl groups, preferably at least 3 hydroxyl groups and, in the event of further use for production of rigid polyurethane foams, 4 to 8 hydroxyl groups or at least one, preferably at least two primary or secondary, especially primary, amino groups.

Useful starter molecules with at least 3 and preferably from 4 to 8 hydroxyl groups in the molecule preferably include trimethylolpropane, glycerol, pentaerythritol, sugar compounds such as for example glucose, sorbitol, mannitol and sucrose, polyhydric phenols, resols, e.g., oligomeric condensation products of phenol and formaldehyde and Mannich condensates of phenols, formaldehyde and dialkanolamines and also melamine.

Useful starter molecules with two or more primary amino groups in the molecule preferably include aromatic di-and/or polyamines, for example phenylenediamines, 2,3-tolylenediamine, 2,4-tolylenediamine, 3,4-tolylenediamine, 2,6-tolylenediamine, 4,4′-diaminodiphenylmethane, 2,4′-diaminodiphenylmethane and 2,2′-diaminodiphenylmethane, especially mixed with their higher homologs and also aliphatic di-and polyamines, such as ethylenediamine. Preference is given to diphenylmethane and its higher homologs and tolylenediamine, and here especially the 2,3-and 3,4-isomers. Ethylenediamine is a preferable aliphatic amine.

Polyether polyols have a functionality of preferably 3 to 8 and hydroxyl numbers of preferably 100 mgKOH/g to 1200 mgKOH/g and especially 240 mgKOH/g to 570 mgKOH/g.

The polyols mentioned can be used alone or as mixture.

In one preferable embodiment of the invention, component a) is a mixture of at least two polyols and especially at least two polyether alcohols.

In one particularly preferable embodiment of the invention, component a) is a mixture of a high-functionality polyether alcohol ai) and an amine-started polyether alcohol aii).

Polyol ai) is preferably a polyether alcohol started using a sugar, optionally mixed with a polyfunctional alcohol. The sugar is preferably sucrose and/or sorbitol. The polyfunctional alcohol is a glycol, for example ethylene glycol or propylene glycol, or glycerol. It is most preferable to use glycerol. Component ai) preferably has a functionality of 4 to 8 and a hydroxyl number of 300 to 600 mgKOH/g.

Polyol aii) is preferably a polyether alcohol started using an amine and especially using an aromatic amine. Useful starters include particularly the abovementioned aromatic amines. It is preferable to use tolylenediamine (TDA), in which case the 2,3-and 3,4-isomers, also known as vicinal TDA, are used. Polyol aii) preferably has a functionality of 3 to 6 and a hydroxyl number in the range between 300 and 600 mg KOH/g.

In a further preferable embodiment of the invention, the microemulsions further comprise water. Water is preferably used in an amount of 0.5% to 5% by weight, based on the weight of the microemulsions.

The water used in the microemulsions may also be in microemulsified form. For this, the polar groups of the amphiphilic molecules will assume an orientation toward the water molecules. Water is then taken up in micellar or bicontinuous structures. Blowing agent compatibility, i.e., a clear, stable formulation of the polyol is likewise improved by this microemulsion.

The present invention also provides mixtures comprising
a) at least one compound having two or more isocyanate-reactive hydrogen atoms,
c) at least one amphiphilic compound capable of causing said compounds a) and at least one apolar organic compound b) to build a microemulsion, as described above.

The above remarks apply with respect to components a) and c).

As mentioned, the microemulsions of the present invention are preferably used for production of polyurethane foams, especially for production of rigid polyurethane foams.

For this, the microemulsions are reacted with polyisocyanates.

The present invention therefore also provides a process for production of polyurethane foams by reaction of
d) polyisocyanates with
a) compounds having two or more isocyanate-reactive hydrogen atoms in the presence of
b) blowing agents,
which process comprises utilizing said components a) and b) in the form of a microemulsion according to the invention.

Useful polyisocyanates preferably include aromatic polyfunctional isocyanates.

Specific examples are 2,4-and 2,6-tolylene diisocyanate (TDI) and the corresponding isomeric mixtures, 4,4′-, 2,4′-and 2,2′-diphenylmethane diisocyanate (MDI) and the corresponding isomeric mixtures, mixtures of 4,4′-and 2,4′-diphenylmethane diisocyanates, polyphenyl-polymethylene polyisocyanates, mixtures of 4,4′-, 2,4′-and 2,2′-diphenylmethane diisocyanates and polyphenyl-polymethylene polyisocyanates (polymer MDI) and mixtures of polymer MDI and tolylene diisocyanates. Organic di-and polyisocyanates can be used individually or in the form of mixtures.

Use is frequently also made of so-called modified polyfunctional isocyanates, i.e., products obtained by chemical conversion of organic di-and/or polyisocyanates. Examples are di-and/or polyisocyanates comprising isocyanurate and/or urethane groups. Modified polyisocyanates may optionally be mixed with each other or with unmodified organic polyisocyanates such as for example 2,4′-and 4,4′-diphenylmethane diisocyanates, polymer MDI, 2,4-and/or 2,6-tolylene diisocyanates.

In addition, reaction products of polyfunctional isocyanates with polyfunctional polyols and also mixtures thereof with other di-and polyisocyanates can also be used.

A particularly advantageous organic polyisocyanate is polymer MDI having an NCO content of 29% to 33% by weight and a 25° C. viscosity in the range from 150 to 1000 mPa·s.

Foams are typically produced in the presence of catalysts and also, if necessary, further, auxiliary and/or addition agents.

Useful catalysts include particularly compounds that greatly speed the reaction of isocyanate groups with isocyanate-reactive groups.

Catalysts of this type are strong basic amines, for example secondary aliphatic amines, imidazoles, amidines and also alkanolamines.

When the rigid foam is to incorporate isocyanurate groups, specialty catalysts are needed. Typically metal carboxylates, especially potassium acetate and its solutions, are used as isocyanurate catalysts.

Catalysts can be used as required alone or in any desired mixtures with each or one another.

Useful auxiliaries and/or additive agents b4) include the conventional materials for this purpose, examples being surface-active substances, foam stabilizers, cell regulators, fillers, pigments, dyes, flame retardants, hydrolysis control agents, antistats, fungistats and bacteriostats.

These can be admixed to the microemulsions, or else be added separately, before or after production of polyurethanes.

To produce rigid polyurethane foams, the polyisocyanates and the microemulsion are made to react in such amounts that the isocyanate index is in a range between 125 and 220 and preferably between 145 and 195.

The present invention also provides corresponding polyurethane foams obtainable by the process of the invention.

The microemulsions of the present invention are notable for very good stability in storage. Additional auxiliaries hitherto used to stabilize the polyol component comprising blowing agent, for example long-chain polyols, can be dispensed with.

The examples which follow illustrate the invention.

Production of Polyol Mixtures

Raw materials used:

Polyol A: polyether alcohol from sucrose, glycerol and propylene oxide, functionality 5.1, hydroxyl number 450, viscosity 18 500 mPa·s at 25° C.

Polyol B: polyether alcohol from vicinal TDA, ethylene oxide and propylene oxide, ethylene oxide content: 15%, functionality 3.8, hydroxyl number 390, viscosity 13 000 mPa·s at 25° C.

Polyol C: polyether alcohol from vicinal TDA, ethylene oxide and propylene oxide, ethylene oxide content: 15%, functionality 3.9, hydroxyl number 160, viscosity 650 mPa·s at 25° C.

Stabilizer: Tegostab® B 8491 (foam stabilizer based on polyether polysiloxanes from Evonik)

Catalyst 1: dimethylcyclohexylamine (DMCHA)

Catalyst 2: pentamethyldiethylenetriamine (PMDETA)

Catalyst 3: N,N′,N′-trisdimethylaminopropylhexahydrotriazine

S-Maz 20: sorbitan monolaurate (BASF)

The reported raw materials to prepare polyol components as reported in Tables 1,2 and 3. Phase stability was tested after 24 h.

TABLE 1

| | 1 | 2 (inventive) |
|---|---|---|
| polyol component [pbw] | | |
| polyol A | 60 | 60 |
| polyol B | 23 | 23 |
| polyol C | 10 | — |
| S-Maz 20 | — | 5 |
| Polyol component [pbw] | | |
| n-decanol | — | 5 |
| water | 2.55 | 2.55 |
| stabilizer | 2.75 | 2.75 |
| catalyst | 1.7 | 1.7 |
| cyclopentane | 15 | 15 |
| phase stability at 6° C. after 24 h | cloudy | homogeneous |

TABLE 2

| polyol component [pbw] | 3 | 4 (inventive) |
|---|---|---|
| polyol A | 53 | 53 |
| polyol B | 36 | 36 |
| polyol C | 4 | — |
| S-Maz 20 | — | 2 |
| n-decanol | — | 2 |
| water | 2.55 | 2.55 |
| stabilizer | 2.75 | 2.75 |
| catalyst | 1.7 | 1.7 |
| cyclopentane | 15 | 15 |
| phase stability at 6° C. after 24 h | cloudy | homogeneous |

TABLE 3

| polyol component [pbw] | 5 | 6 (inventive) |
|---|---|---|
| polyol A | 57 | 57 |
| polyol B | 30 | 30 |
| polyol C | 6 | — |
| S-Maz 20 | — | 3 |
| n-decanol | — | 3 |
| water | 2.55 | 2.55 |
| stabilizer | 2.75 | 2.75 |
| catalyst | 1.7 | 1.7 |
| cyclopentane | 15 | 15 |
| phase stability at 23° C. after 24 h | cloudy | homogeneous |

Examples 1, 3 and 5 are comparative examples and they are cloudy after 24 h. The systems in Examples 2, 4 and 6 (inventive) featuring a surfactant mixture consisting of equal parts of S-Maz 20 and n-decanol are monophasic and clear after 24 h, which points to a phase-stable component.

We claim:

1. A microemulsion comprising
a) at least one compound having two or more isocyanate-reactive hydrogen atoms,
b) at least one apolar organic compound,
c) at least one halogen-free compound effective in causing said compounds a) and b) to build a microemulsion, comprising at least one amphiphilic compound ci) selected from the group consisting of nonionic surfactants, polymers and mixtures thereof, and at least one compound cii), other than ci), selected from compounds having an apolar portion having a carbon chain length of 6 or more and one or more OH or NH groups as polar portion and mixtures thereof.

2. The microemulsion according to claim 1 wherein the apolar organic compound b) is selected from the group comprising alkanes having an unbranched chain and 3 to 7 carbon atoms in the molecule, alkanes having a branched chain and 3 to 7 carbon atoms in the molecule, cycloalkanes having 3 to 7 carbon atoms in the molecule and alkenes having 3 to 7 carbons in the molecule.

3. The microemulsion according to claims 1 and 2 wherein the apolar organic compound b) comprises compounds comprising fluorine.

4. The microemulsion according to any one of claims 1 to 3 wherein said compound a) is selected from the group comprising polyether alcohols and polyester alcohols.

5. The microemulsion according to claims 1 and 4 wherein said compound a) is a polyether alcohol.

6. The microemulsion according to any one of claims 1 to 5 wherein said compound a) is a polyether alcohol having a functionality of 2 to 8 and a molecular weight Mw of 400 to 10 000.

7. The microemulsion according to any one of claims 1 to 6 wherein said compound cii) is a nonionic compound.

8. The microemulsion according to any one of claims 1 to 7 which is optically clear.

9. The microemulsion according to any one of claims 1 to 8 which in small angle x-ray scattering (SAXS) has a characteristic, monotonously descending, sigmoidal signal and structures between 2 and 40 nm assuming a globular model.

10. The microemulsion according to any one of claims 1 to 9 wherein the components c) are present in an amount of above 0% to below 20% by weight, based on the weight of the sum of components a), b) and c).

11. A mixture comprising
a) at least one compound having two or more isocyanate-reactive hydrogen atoms,
c) at least one amphiphilic compound capable of causing said compounds a) and at least one apolar organic compound b) to build a microemulsion, according to claim 1.

12. A process for production of polyurethane foams by reaction of
d) polyisocyanates with
a) compounds having two or more isocyanate-reactive hydrogen atoms in the presence of
b) blowing agents,
which process comprises utilizing said components a) and b) in the form of a microemulsion according to claims 1 to 10.

13. A polyurethane foam obtainable according to claim 12.
